(19) United States
(12) Patent Application Publication
(10) Pub. No.: US 2015/0250144 A1
(43) Pub. Date: Sep. 10, 2015

(54) PET LEASH

(71) Applicant: Hsi-Chuen LIN, Hemei Township (TW)

(72) Inventor: Hsi-Chuen LIN, Hemei Township (TW)

(73) Assignee: PETRlCK ENTERPRlSE CO., LTD, Hemei Township (TW)

(21) Appl. No.: 14/200,765

(22) Filed: Mar. 7, 2014

(51) Int. Cl. A01K 27/00

(52) U.S. Cl. CPC A01K 27/001; A01K 27/003

(57) ABSTRACT

A pet leash has an extended leash section, in an extended leash body form, with a pulling and holding end and an extended end. A scalable adjustment ring is connected to the extended end of the extended leash section, A C-shaped collar is connected to the scalable adjustment ring. The two opposite ends of the C-shaped collar are provided with two buckles to be connected to the adjustment ring. The two buckles can move along the shape of the adjustment ring to change the diameter of the collar. Thus, through adjusting the diameter size of the scalable adjustment ring, the maximum expanding extent of the diameter size of the C-shaped collar can be restricted to further achieve the tightening efficacy of a pet leash when a pet attempts a sudden rush, as well as effectively preventing the pet from escaping from it when it is released.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a pet leash, and more particularly to a pet leash in the innovative structural form disclosed, which is capable of achieving a tightening efficacy when a pet attempts a sudden rush and effectively preventing the pet from escaping from it when it is released.

2. Description of Related Art Including Information Disclosed Under 37 CFR 1.97 and 37 CFR 1.98

In the structural design of a conventional pet leash, in order to prevent the pet from making a sudden rush and being out of control, the relevant industry has developed a kind of structural form where the collar of the pet leash tightens around the pet's neck when the pet attempts a sudden rush. This helps to achieve the training function of preventing a pet from suddenly rushing away, or pulling on the leash. However, since the restoring force of such a conventional structure after the tightening action is produced is poor, it is liable to pose a threat to a pet's life due to the overlong tightening state.

Based on the problem of the conventional pet leash structure a disclosed in the preceding paragraph, the relevant industry has further developed another kind of conventional pet leash structure subsequently, mainly designing the collar part of a pet leash into a C-shaped belt structure with two buckle ends. The two buckle ends are then buckled together and connected onto an annular belt body, in a state capable of making displacement movement along the annular belt body. The other side of the annular belt body is connected with the end of the main pet leash body. This conventional pet leash, in the structural use, mainly utilizes the displacement movement feature of the two buckle ends at the collar part along the annular belt body. In the case of a sudden rush by a pet, the annular belt body would be pulled into a flat shape, causing the two buckle ends to come close to each other due to the relative displacement so as to produce the tightening efficacy. On the contrary, when the pet retreats and relaxes, the annular belt body would restore from the flat shape back to the round shape when the two buckle ends move away from each other relatively into a released state. Although such a conventional pet leash structure can improve the problem indicated in the previous paragraph, another problem is derived in a relative sense, i.e., when the two buckle ends move away from each other relatively into a released state, the pet can easily break away from the belt it the release extent of the annular belt body is restored to the original size suitable to put through a pet's head, thus causing such a conventional pet leash structure to still have the problem and shortcoming of being easily got rid of by a pet and the improvements being really necessary.

Thus, to overcome the aforementioned problems of the prior art, it would be an advancement if the art to provide an Unproved structure that can significantly improve the efficacy.

Therefore, the inventor has provided the present invention of practicability after deliberate design and evaluation based on years of experience in the production, development and design of related products.

### BRIEF SUMMARY OF THE INVENTION

The “pet leash” disclosed in the present invention is to utilize the innovative and unique structural form and technical characteristics constituted mainly by said extended leash section, scalable adjustment ring and C-shaped collar to enable the present invention, against the “Prior Art” mentioned conventional structure, to restrict the maximum expanding extent of the diameter size of the C-shaped collar through adjusting the diameter size of the scalable adjustment ring, and further achieve the tightening efficacy of a pet leash when a pet attempts a sudden rush as well as the efficacy and practical progress of effectively preventing the pet from escaping from it when it is released.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of the preferred embodiment of the pet leash structure of the present invention.

FIG. 2 is a schematic plan of the usage state of the pet leash of the present invention.

FIG. 3 is a schematic plan of the ring size diminishing state of the scalable adjustment ring of the present invention.

FIG. 4 is a schematic diagram of the tightening efficacy state produced on a pet's neck by a C-shaped collar when a pet rushes forward suddenly.

FIG. 5 is a schematic diagram of the rotatable connector provided in the extended leash section of the present invention that can make the pulling & holding end and the extended end of the extended leash section rotate relative to each other to avoid the entanglement.

### DETAILED DESCRIPTION OF THE INVENTION

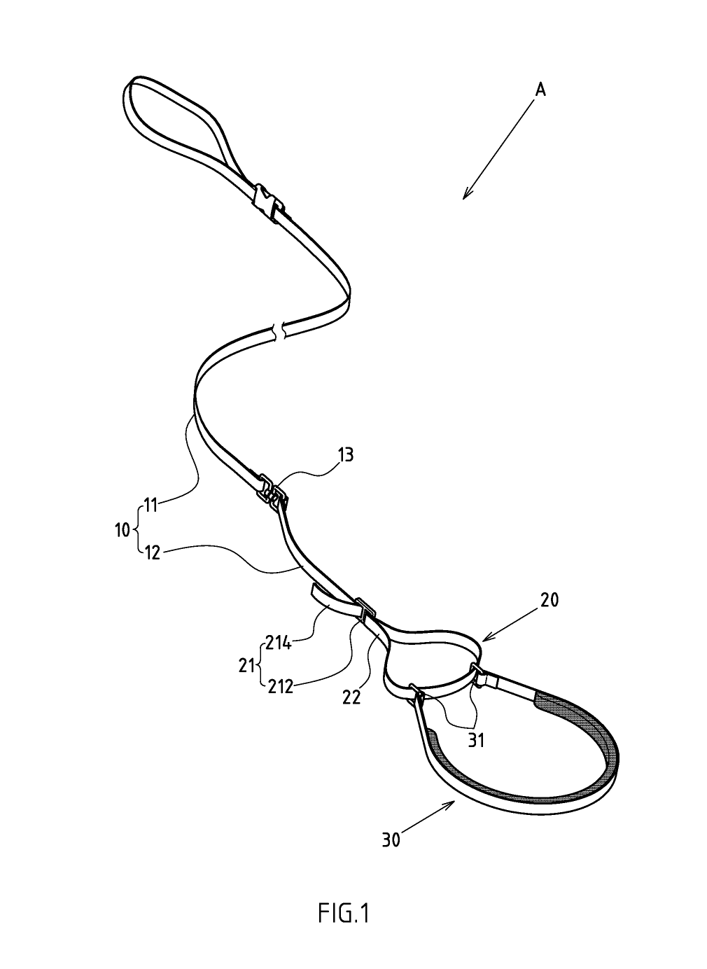

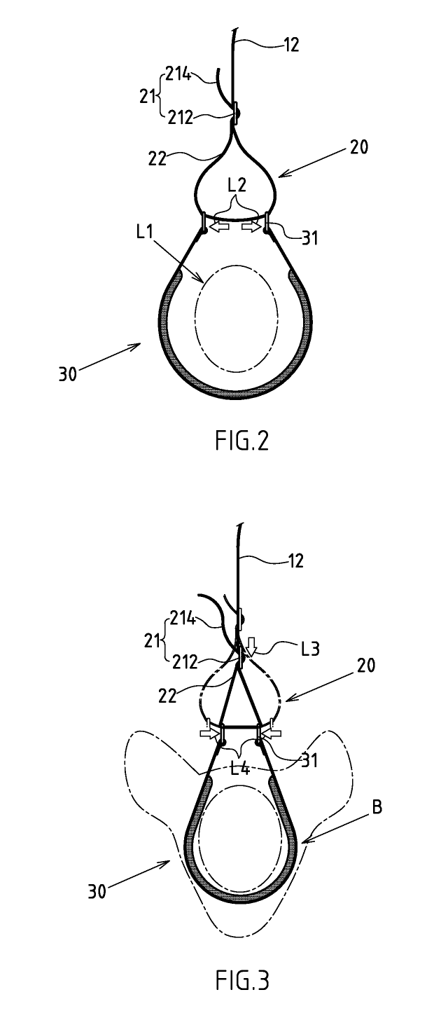

Referring to FIGS. 1 and 2 for the preferred embodiment of the pet leash of the present invention, though said embodiments are for illustrative purposes only and the patent application is not restricted by this structure, said pet leash A comprises of the following components.

An extended leash section 10 is provided in an extended leash body form, and comprises a pulling and holding end 11 and an extended end 12.

A scalable adjustment ring 20 is provided in a closed circle form and connected to the extended end 12 of the extended leash section 10. Said scalable adjustment ring 20 has an adjustment part 21 used to adjust the ring size of the scalable adjustment ring 20.

A C-shaped collar 30 is provided in a C shape and connected to the scalable adjustment ring 20. The two opposite ends of the C-shaped collar 30 is provided with two buckles 31 to be connected to the scalable adjustment ring 20. The two buckles 31 can move along the shape of the scalable adjustment ring 20 to change the diameter size of the C-shaped collar 30.

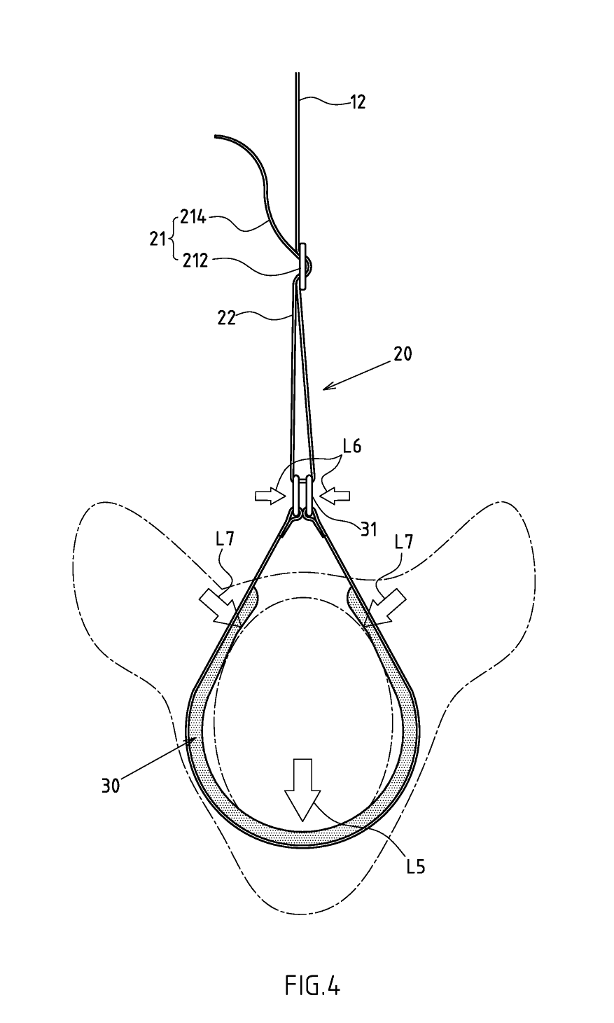

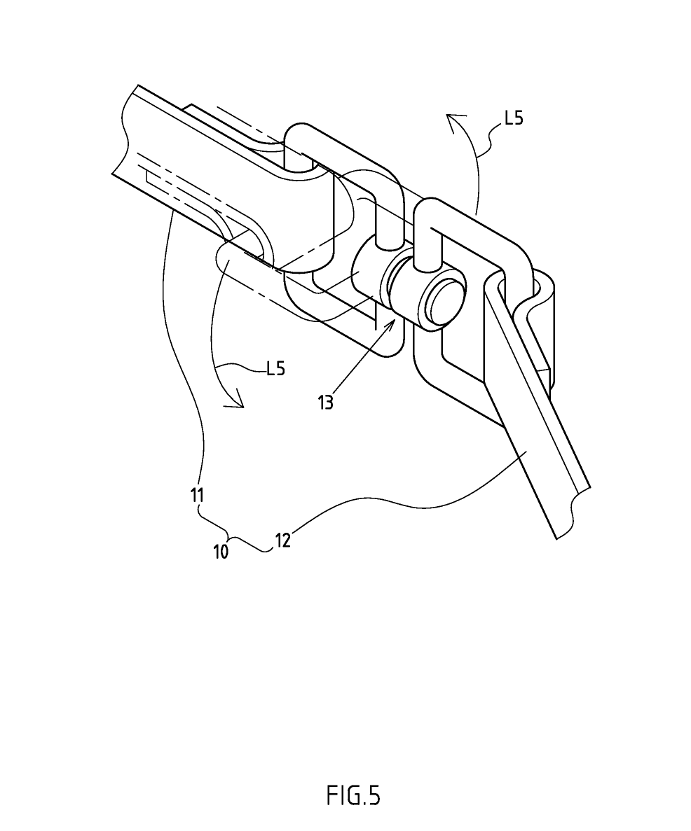

According to the above structure, the actual use of the Pet Leash A disclosed by the present invention is as shown in FIG. 2. The enclosed part formed by its C-shaped collar 30 is set on a pet's neck (at the location as indicated by Arrow L1). Prior to setting the C-shaped collar 30 in place, the user must first adjust the ring size of the scalable adjustment ring 20 to an appropriate extent through the adjustment part 21 so that the two buckles 31 of said C-shaped collar 30 could move outwards (as shown by Arrow L2) to an adequately stretched position where the pet's head is able to be put through the C-shaped collar 30 smoothly and the latter slide to its neck. Next, as shown in FIG. 3, after the C-shaped collar 30 is properly set on the pet's neck, the user can adjust the scalable adjustment ring 20 again through the adjustment part 21 (as shown by Arrow L3) to diminish the ring size. As a result, the maximum outward movement extent of the two buckles 31 of the C-shaped collar 30 is diminished (as shown by Arrow L4), namely, the stretched extent of the C-shaped collar 30 at this time being smaller than the state as shown in FIG. 2, making it difficult for the C-shaped collar 30 to go over the pees head reversely (the border as indicated by Arrow B in FIG. 3), and further achieving the efficacy of effectively prevent loosening (prevent pet from escaping). As for the function part of Pet Leash A's capability of achieving a tightening efficacy when a pet attempts a sudden rush disclosed by the present invention, it is because only a mall gap would be left between the C-shaped collar 30 and the pet's neck when the C-shaped collar 30 is set on the pet's neck. Therefore, as shown in FIG. 4, when a pet rushes forward suddenly (as shown by Arrow L5), the scalable adjustment ring 20 would be pulled into a flat shape, causing the two buckles 31 to move Close to each other relatively (as shown by Arrow L6) and the C-shaped collar 30 to contract instantly to produce the tightening efficacy on a pees neck (as shown by Arrow L7) so that the pet would slow down because of the discomfort. The purpose of preventing sudden rushes by a pet can be achieved through long time training.

As shown in FIG. 1, said scalable adjustment ring 20 can be extended end 12 of the extended leash section 10 and then folded back to form a fold-back end 22. The adjustment part 21 is constituted by a slide buckle 212 provided at the extended end 12 of the extended leash section 10 and a pulling & control section 214 formed by using the fold-back end 22 going through the slide buckle 212.

As shown in FIG. 5, a rotatable connector 13 is even provided in the extended leash section 10, so that the pulling & bolding end 11 and the extended end 12 of the extended leash section 10 can rotate relative to each other (as shown by Arrow L5) in order to avoid the entanglement of the extended leash section 10.

1. A pet leash; comprising:
an extended leash section, in an extended leash body form composing a pulling and holding end and an extended end;
a scalable adjustment ring, in a closed circle form and connected to the extended end of the extended leash section; said scalable adjustment ring has an adjustment part used to adjust the ring size of the scalable adjustment ring;
a C-shaped collar, in a C shape and connected to the scalable adjustment ring; the two opposite ends of the C-shaped collar are provided with two buckles to be connected to the scalable adjustment ring 20; the two buckles can move along the shape of the scalable adjustment ring to change the diameter size of the C-shaped collar;
thus, through adjusting the diameter size of the scalable adjustment ring, the maximum attainable diameter size of the C-shaped collar could be restricted.

2. The structure defined in claim 1, wherein on the scalable adjustment ring, a fold-back end is formed by the extended end of the extended leash section by way of further extending and folding back reversely; the adjustment part is constituted by a slide buckle provided at the extended end of the extended leash section and a pulling and control section formed by using the fold-back end going through the slide buckle.

3. The structure defined in claim 1, wherein a rotatable connector is even provided in the extended leash section, so that the pulling, and holding end and the extended end of the extended leash section can rotate relative to each other in order to avoid the entanglement of the extended leash section.
